(19) United States
(12) Patent Application Publication
(10) Pub. No.: US 2012/0225772 A1
(43) Pub. Date: Sep. 6, 2012

(54) SO3 REDUCTION CATALYST FOR PURIFYING AN EXHAUST GAS, PREPARATION PROCESS THEREOF, AND EXHAUST GAS PURIFYING METHOD USING THE CATALYST

(75) Inventors: Katsumi NOCHI, Hiroshima-shi (JP); Masanao YONEMURA, Hiroshima-shi (JP); Kozo IIDA, Hiroshima-shi (JP); Yoshiaki OBAYASHI, Hiroshima-shi (JP); Shigeru NOJIMA, Hiroshima-shi (JP); Toshiyuki ONISHI, Nagasaki-shi (JP)

(73) Assignee: MITSUBISHI HEAVY INDUSTRIES, LTD., Tokyo (JP)

(21) Appl. No.: 13/471,033

(22) Filed: May 14, 2012

Related U.S. Application Data
(62) Division of application No. 11/908,902, filed on Dec. 1, 2007.

(51) Int. Cl. B01J 23/46; B01J 21/08; B01J 23/652; B01J 21/06

(52) U.S. Cl. 502/261; 502/325; 502/313

(57) ABSTRACT

In the catalyst for purifying a combustion exhaust gas containing nitrogen oxides, 50 wt. % or greater of the amount of Ru and/or Ir to be supported is adjusted to fall within a depth of 150 μm from the surface layer of a substrate; and the catalyst is prepared by immersing the substrate in a metal colloid solution of Ru and/or Ir to be supported or an aqueous solution containing at least one compound selected from compounds of Ru and/or Ir to be supported.

### RELATED APPLICATIONS

This application is a divisional of Ser. No. 11/908,902 filed Dec. 1, 2007, which is the National Stage Entry of PCT/JP2005/006781 filed Apr. 6, 2005, each of which is incorporated herein by reference in its entirety.

### TECHNICAL FIELD

The present invention relates to an SO₃ reduction catalyst for purifying an exhaust gas, a preparation process of the catalyst, and an exhaust gas purifying method using the catalyst.

An exhaust gas generated during combustion of coarse fuels such as heavy oil and orimulsion contains a large amount of sulfur oxides (which are also called SOₓ) as well as nitrogen oxides (which are also called NOₓ). Of SOₓ, SO₃ is a corrosive gas. It is condensed as sulfuric acid, ammonium sulfate, acid ammonium sulfate or the like in a NOx removal catalyst or in an air preheater or electric dust collector downstream of the catalyst and causes corrosion or clogging. Moreover, as soon as a load on a boiler or the like increases, a large amount of ammonium sulfate or the like in the form of a mist is discharged from a chimney. An exhaust gas colored in white is thus discharged.

Although most of SOₓ in an exhaust gas generated during combustion of coarse fuel oils is SO₂, a large amount of SO₃ is sometimes discharged, depending on a combustion method.

There has accordingly been a demand for reduction in the SO₃ content in an exhaust gas.

Patent Document 1: Japanese Patent Laid-Open No. Hei 10-249163

### DISCLOSURE OF THE INVENTION

### Problems that the Invention is to Solve

With the foregoing in view, the present invention has been made. An object of the present invention is to provide an SO₃ reduction catalyst for purifying an exhaust gas capable of efficiently reducing the amount of SO₃ that is present in a combustion exhaust gas and is a starting substance of an S-containing substance such as acid ammonium sulfate causing deterioration in the performance of a catalyst and corrosion of apparatuses disposed downstream of the catalyst or capable of controlling the generation of SO₃ in the catalyst itself; a preparation process of the catalyst; and an exhaust gas purifying method using the catalyst.

### Means for Solving the Problems

With a view to attaining the above-described object, the present invention provides a catalyst for purifying a combustion exhaust gas containing nitrogen oxides. The catalyst contains 50 wt. % or greater of the support amount of Ru and/or Ir within a depth of 150 μm from the surface layer of a substrate.

In another aspect of the present invention, there is also provided a preparation process of an SO₃ reduction catalyst for purifying an exhaust gas. According to this preparation process, a catalyst containing 50 wt. % or greater of the support amount of Ru and/or Ir within a depth of 150 μm from the surface layer of a substrate is prepared by immersing the substrate in a metal colloid solution—which has been prepared by mixing an aqueous solution having, dissolved therein, a raw material for Ru and/or Ir to be supported on the substrate and a reducing agent composed of an organic acid or by mixing an aqueous solution having, dissolved therein, a raw material of Ru and/or Ir to be supported on the substrate, a reducing agent composed of an organic acid, and a pH regulator and then subjecting the resulting mixture to reduction treatment—or in an aqueous solution containing at least one material selected from the group consisting of nitrates, chlorides, bromides, sulfates, acetates, oxalates, iodides, ammine chlorides, ammine hydroxides and ammine nitrates of Ru and/or Ir to be supported on the substrate.

The above-described preparation process may comprise supporting Ru and/or Ir on a powder composed of an inorganic compound having, as a main component, at least one compound selected from the group consisting of TiO₂, SiO₂, ZrO₂ and composite oxides thereof to prepare a catalyst powder, preparing a slurry from the catalyst powder, and then applying the slurry to the substrate.

In a further aspect of the present invention, there is also provided an exhaust gas purifying method, which comprises using an exhaust-gas-purifying SO₃ reduction catalyst of the present invention.

In a still further aspect of the present invention, there is also provided a preparation process of a metal colloid solution, which comprises mixing an aqueous solution having, dissolved therein, a raw material for Ru and/or Ir to be supported on a substrate and a reducing agent composed of an organic acid, or mixing an aqueous solution having, dissolved therein, a raw material for Ru and/or Ir to be supported on a substrate, a reducing agent composed of an organic acid, and a pH regulator and then, subjecting the resulting mixture to reduction treatment.

### Advantage of the Invention

According to the present invention, there are provided an SO₃ reduction catalyst for purifying an exhaust gas capable of efficiently reduce the amount of SO₃ which is present in a combustion exhaust gas and is a starting substance of an S-containing substance such as acid ammonium sulfate causing deterioration in the performance of the catalyst or corrosion of apparatuses downstream of the catalyst or capable of controlling the generation of SO₃ in the catalyst itself; a preparation process of the catalyst; and an exhaust gas purifying method using the catalyst.

### BRIEF DESCRIPTION OF DRAWINGS

FIG. 1 is a graph showing the relationship between a depth from the surface layer of a substrate and an Ru content ratio in an exhaust-gas-purifying SO₃ reduction catalyst of the present invention prepared in accordance with Test 1.

FIG. 2 is a graph showing the relationship between a depth from the surface layer of a substrate and an Ru content ratio in the catalyst of Comparative Example 1 prepared in accordance with Test 1.

### BEST MODE FOR CARRYING OUT THE INVENTION

The SO₃ reduction catalyst for purifying an exhaust gas, preparation process of the catalyst, and exhaust gas purifying method using the catalyst, each according to the present invention will hereinafter be described more specifically.

The SO₃ reduction catalyst for purifying an exhaust gas according to the present invention is a catalyst for purifying a combustion exhaust gas containing nitrogen oxides and it contains 50 wt. % or greater of the support amount of Ru and/or Ir within a depth of 150 μm from the surface layer of a substrate.

As the substrate, at least one material selected from the group consisting of TiO₂ (titania), SiO₂ (silica), ZrO₂ (zirconia), and composite oxides thereof is suited. Such a substrate has preferably a honeycomb structure. The substrate having a honeycomb structure is typically prepared by adding a processing improvement agent to a raw material slurry of the substrate, for example, a metatitanic acid slurry when the substrate is titania, kneading the resulting mixture in a heating kneader while evaporating water to yield a catalyst paste, extruding the resulting paste into a honeycomb shape, and drying and calcining it as a honeycomb substrate. This honeycomb substrate will serve as a carrier (monolithic carrier) of a catalyst.

An aqueous solution for obtaining colloid particles is prepared by mixing an aqueous solution having, dissolved therein, a raw material for Ru and/or Ir to be supported on a substrate and a reducing agent composed of an organic acid. Alternatively, an aqueous solution of a metal salt for obtaining colloid particles is prepared by mixing an aqueous solution having, dissolved therein, a raw material for Ru and/or Ir to be supported on a substrate, a reducing agent composed of an organic acid, and a pH regulator.

The raw material for Ru and/or Ir to be supported on a substrate is preferably at least one material selected from the group consisting of nitrates, chlorides, bromides, sulfates, acetates, oxalates, iodides, ammine chlorides, ammine hydroxides and ammine nitrates of Ru and nitrates, chlorides, bromides, sulfates, acetates, oxalates, iodides, ammine chlorides, ammine hydroxides and ammine nitrates of Ir.

As the reducing agent, organic acids are preferred. Preferred examples include sodium citrate, potassium citrate, carboxylic acids such as acetic acid, formic acid and malic acid, alcohols such as methanol, ethanol and propanol, ethers such as diethyl ether, and ketones such as methyl ethyl ketone.

Examples of the pH regulator include inorganic acids such as hydrochloric acid and sulfuric acid and alkaline substances such as sodium hydroxide, potassium hydroxide and aqueous ammonia.

A metal colloid solution can be prepared by subjecting such an aqueous solution of a metal salt to reduction treatment to obtain colloid particles. The reduction treatment is carried out typically by heating at a temperature from 80 to 100° C. for from 30 minutes to 2 hours.

The SO₃ reduction catalyst for purifying an exhaust gas according to the present invention is available by immersing the substrate in the metal colloid solution to allow a metal to be supported by the substrate. In this case, in order to incorporate 50 wt. % or greater of the amount of Ru and/or Ir to be supported by the substrate within a depth of 150 μm from the surface layer of the substrate, the concentration in the metal colloid is adjusted to from 0.5 mmol-Ru/L to 140 mmol-Ru/L when the material to be supported is Ru, while the concentration in the metal colloid is adjusted to from 0.5 mmol-Ir/L to 140 mmol-Ir/L when the material to be supported is Ir. The immersion time is adjusted to from 30 seconds to 5 hours.

The SO₃ reduction catalyst for purifying an exhaust catalyst according to the present invention can also be prepared by immersing the substrate in an aqueous solution containing at least one material selected from the group consisting of nitrates, chlorides, bromides, sulfates, acetates, oxalates, iodides, ammine chlorides, ammine hydroxides and ammine nitrates of Ru and nitrates, chlorides, bromides, sulfates, acetates, oxalates, iodides, ammine chlorides, ammine hydroxides and ammine nitrates of Ir, followed by drying and calcining. In this case, in order to incorporate 50 wt. % or greater of the amount of Ru and/or Ir to be supported by the substrate within a depth of 150 μm from the surface layer of the substrate, the concentration in the aqueous solution is adjusted to 0.5 mmol-Ru/L to 0.4 mol-Ru/L when the material to be supported is Ru, while the concentration in the aqueous solution is adjusted to 0.5 mmol-Ir/L to 0.4 mol-Ir/L when the material to be supported is Ir. The immersion time is adjusted to from 30 seconds to 5 hours.

Moreover, the catalyst of the present invention can also be prepared by converting, into a slurry, a catalyst powder obtained by immersing a powder of a raw material similar to that of the substrate in a metal colloid solution as described above to allow the metal to be supported on the substrate and then drying and calcining, or a catalyst obtained by immersing a substrate in an aqueous solution containing at least one material selected from the group consisting of nitrates, chlorides, bromides, sulfates, acetates, oxalates, iodides, ammine chlorides, ammine hydroxides and ammine nitrates and then drying and calcining; and then applying the resulting slurry to a substrate formed from at least one compound selected from the group consisting of TiO₂ (titania), SiO₂ (silica), ZrO₂ (zirconia) and composite oxides thereof. In this case, in order to incorporate 50 wt. % or greater of the amount of Ru and/or Ir to be supported by the substrate within a depth of 150 μm from the surface layer of the substrate, the coating weight of the slurry is adjusted to from 50 to 200 g/m².

The SO₃ reduction catalyst for purifying an exhaust gas according to the present invention may contain from 0 to 30 wt. %, based on the total weight of the catalyst, of WO₃ and/or MoO₃ as a promoter. Such a promoter can be incorporated in the catalyst by preparing an appropriate colloid solution or aqueous solution of it and then immersing the substrate in the resulting solution.

The SO₃ reduction catalyst for purifying an exhaust gas according to the present invention can have an NO removal performance by attaching an active NOₓ removal component such as vanadium or tungsten to it.

The Ru and Ir to be supported on the substrate may be used either singly or in combination. The catalyst has a catalytic activity when it contains either or both of Ru and Ir in an amount of 0.002 part by weight or greater based on 100 parts by weight of the substrate. It has preferably a high catalytic activity when the amount is 0.02 part by weight or greater.

Use of the SO₃ reduction catalyst for purifying an exhaust gas according to the present invention which is equipped with the above-described features makes it possible to efficiently decrease the amount of SO₃ that is present in a combustion exhaust gas and is a starting substance of S-containing substances such as acid ammonium sulfate causing deterioration of the performance of the catalyst and corrosion of apparatuses downstream of the catalyst.

The term “and/or” is used in the specification and claims of this application for precisely expressing three patterns, that is, combination of the two words connected by the term and each of the two words connected by the term, simultaneously in accordance with “Rules for the layout and drafting of Japanese Industrial Standards” of JIS Z8301.

### EXAMPLE 1

Tests and Comparison were carried out as shown in Table 1 in order to confirm the advantages of the present invention. Nos. 1 to 61 in Table 1 mean catalysts of the present invention obtained in Tests 1 to 61 and this table also includes catalysts obtained in Comparative Examples 1 to 3.

In Tests 1 to 25, catalysts of the present invention were prepared by immersing a substrate in an aqueous solution of a salt of Ir or Ru and then drying and calcining the resulting substrate. In Tests 18 and 19, a substrate made of two substances was used.

In Tests 20 to 25, a catalyst containing a promoter was tested.

In Tests 26 to 59, catalysts were each prepared by preparing a metal colloid solution by using a reducing agent, immersing a substrate in the metal colloid solution and then drying and calcining the resulting substrate. In Tests 43 and 44, a substrate made of two substances was used. In Tests 45 to 50, catalysts containing a promoter were tested.

In Tests 60 and 61, coating type catalysts were tested. Described specifically, in Test 60, a catalyst powder was prepared by immersing anatase titania (TiO₂) in an aqueous solution of Ru nitrate to allow 1 part by weight, based on 100 parts by weight of an anatase titania powder, of Ru to be supported by the powder, and after evaporation and drying, calcining the resulting powder at 500° C. for 5 hours. Water was then added to the catalyst powder, followed by grinding in a wet ball mill to obtain a wash coat slurry. A honeycomb substrate (with a pitch of 7.4 mm) made of TiO₂ was immersed in the slurry and dried at 200° C. The coating weight of the catalyst powder was adjusted to 100 g per 1 m² of the surface area of the substrate. The coating type catalyst thus obtained was listed in the table as No. 60. The catalyst of Test 61 was obtained similarly.

In Comparative Example 1, a catalyst obtained by extrusion of a powder prepared by an immersion method was employed. In Comparative Examples 2 and 3, catalysts were prepared in a similar manner to those employed for the preparation of the catalysts of Tests 1 to 60 except for the preparation conditions (concentration of the solution and immersion time).

One example of the preparation procedure of the catalyst of Test 1 will next be described in further detail.

### Test 1:

After addition of a processing improvement agent to 60 kg of a metatitanic acid slurry (TiO₂ content: wt. %), the resulting mixture was kneaded in a heating kneader while evaporating water, whereby a catalyst paste was obtained. The resulting paste was extruded by an extruder into a honeycomb shape having an outside dimension of 75 mm square and 500 mm long. The honeycomb catalyst was dried at 80° C. and then calcined at 500° C. for 5 hours in an air atmosphere.

The catalyst thus obtained by calcining was immersed in an aqueous solution (0.4 mol-Ru/L) of Ru nitrate, dried at 80° C., and calcined at 500° C. for 5 hours in an air atmosphere, whereby the catalyst of Test 1 was obtained.

The substrate of another Test was prepared through substantially the same procedure. Treatment after the immersion in an aqueous solution or metal colloid solution is also similar to that employed in Test 1.

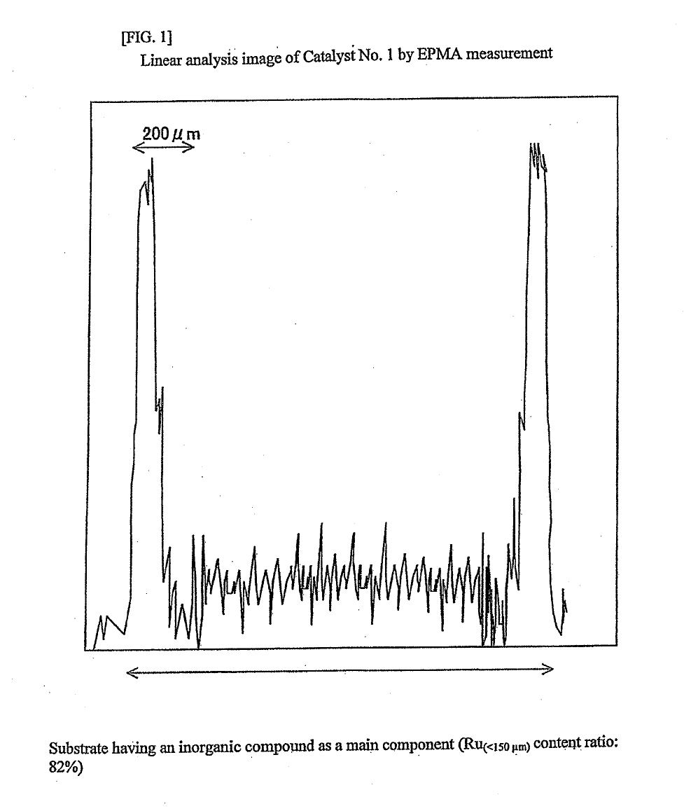

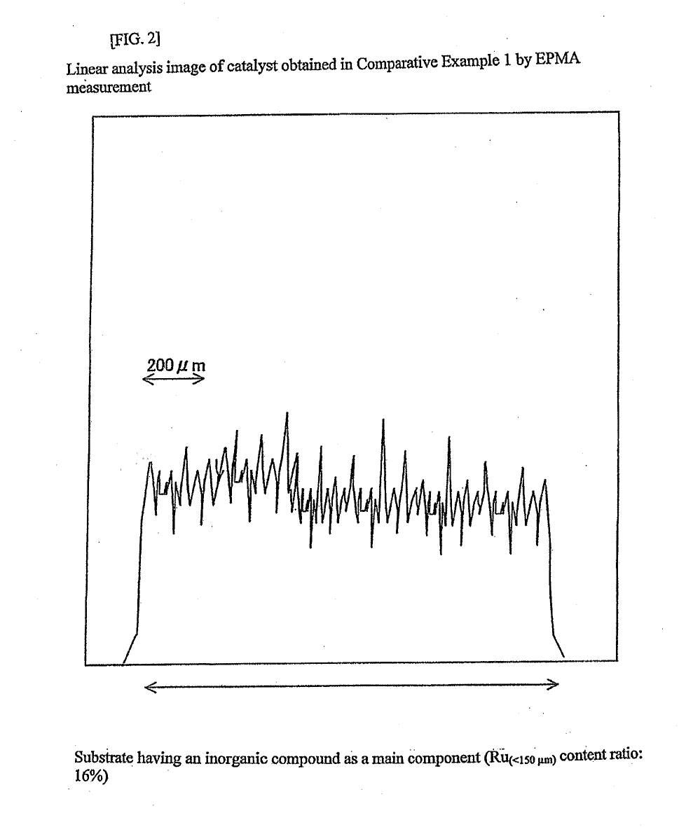

With regard to the catalyst of Test 1, the relationship between an Ru content ratio and a depth from the surface layer of the substrate is shown in FIG. 1. As is apparent from FIG. 1, 50 wt. % or greater of Ru is contained within a depth of 150 μm from the surface layer of the substrate. Since surface layers are on right and left sides of the substrate, there exist two peaks. With regards to the catalyst of Comparative Example 1 shown in FIG. 2, on the other hand, only 16 wt. % of Ru is contained within a depth of 150 μm from the surface layer of the substrate. Also with regards to the catalysts of Tests 2 to 61, 50 wt. % or greater of Ru or Ir is contained within a depth of 150 μm from the surface layer of the substrate. The content ratio of Ru within a depth of 150 μm from the surface layer is expressed by the following equation:

Ru (≦150 μm) content ratio=Ru content within a depth of 150 μm from the surface layer of substrate/Ru content in the whole catalyst

Evaluation Conditions of Catalytic Activity

Evaluation test on the catalytic activity of the catalysts prepared as described above in Tests and Comparative Examples was carried out under the following conditions. The results are as shown in Table 1. They suggest that the catalysts of the present invention obtained in Tests have a sufficient catalytic activity.

Composition of an exhaust gas fed through a catalyst:

NOₓ: 350 ppm, NH₃: 350 ppm, SOₓ: 1500 ppm, SO₃: 50 ppm, O₂: 3%, GHSV: 20,000 h⁻¹, Temperature of catalyst bed: 380° C.

Ammonia is used as a reducing agent of SO₃. SO₃ is reduced by the reduction reaction basically in accordance with the following reaction scheme.

3SO₃+2NH₃→3SO₂+N₂+3H₂O

2SO₃+2NH₃+1/2O₂→2SO₂+N₂+3H₂O

The reaction rate is expressed by the following equation:

Rate of reaction (%)=(1−SO₃ concentration at outlet/SO₃ concentration at inlet)×100

TABLE 1

| | | | | | | | Ru | | | |
|---|---|---|---|---|---|---|---|---|---|---|
| | | | | | | | (≦150 μm) | | | |
| | Composition of active component | | | | | Rate of | Content | | | |
| | Active metal | | Promoter | | Composi- | reaction | ratio of | Preparation process of metal colloid | | |
| | | Raw | | Weight | tion of | at 380° C. | 50% or | Reducing | | Coating type |
| No. | Species | material | Species | (wt. %) | carrier | (%) | greater | agent | Remarks | catalyst |
| 1 | Ru | Nitrate | — | — | TiO2 | 60 | YES | — | — | — |
| | | | | | | | (82%) | | | |
| 2 | Ru | Acetate | — | — | TiO2 | 57 | YES | — | — | — |
| 3 | Ru | Oxalate | — | — | TiO2 | 62 | YES | — | — | — |
| 4 | Ru | Chloride | — | — | TiO2 | 57 | YES | — | — | — |
| 5 | Ru | Bromide | — | — | TiO2 | 62 | YES | — | — | — |
| 6 | Ru | Iodide | — | — | TiO2 | 50 | YES | — | — | — |
| 7 | Ru | Ammine | — | — | TiO2 | 40 | YES | — | — | — |
| | | chloride | | | | | (51%) | | | |
| 8 | Ru | Ammine | — | — | TiO2 | 51 | YES | — | — | — |
| | | hydroxide | | | | | | | | |
| 9 | Ru | Ammine | — | — | TiO2 | 60 | YES | — | — | — |
| | | nitrate | | | | | | | | |
| 10 | Ir | Chloride | — | — | TiO2 | 68 | YES | — | — | — |
| 11 | Ir | Bromide | — | — | TiO2 | 53 | YES | — | — | — |
| 12 | Ir | Iodide | — | — | TiO2 | 49 | YES | — | — | — |
| 13 | Ir | Ammine | — | — | TiO2 | 61 | YES | — | — | — |
| | | chloride | | | | | | | | |
| 14 | Ir | Ammine | — | — | TiO2 | 45 | YES | — | — | — |
| | | hydroxide | | | | | (60%) | | | |
| 15 | Ir | Ammine | — | — | TiO2 | 40 | YES | — | — | — |
| | | nitrate | | | | | (55%) | | | |
| 16 | Ru | Nitrate | — | — | TiO2 | 61 | YES | — | — | — |
| 17 | Ru | Nitrate | — | — | ZrO2 | 61 | YES | — | — | — |
| 18 | Ru | Nitrate | — | — | TiO2— | 68 | YES | — | — | — |
| | | | | | SiO2 | | | | | |
| 19 | Ru | Nitrate | — | — | TiO2— | 65 | YES | — | — | — |
| | | | | | ZrO2 | | | | | |
| 20 | Ru | Nitrate | WO3 | 10 | TiO2 | 70 | YES | — | — | — |
| 21 | Ru | Nitrate | WO3 | 20 | TiO2 | 70 | YES | — | — | — |
| 22 | Ru | Nitrate | WO3 | 30 | TiO2 | 85 | YES | — | — | — |
| 23 | Ru | Nitrate | MoO3 | 10 | TiO2 | 70 | YES | — | — | — |
| 24 | Ru | Nitrate | MoO3 | 20 | TiO2 | 72 | YES | — | — | — |
| 25 | Ru | Nitrate | MoO3 | 30 | TiO2 | 79 | YES | — | — | — |
| 26 | Ru | Nitrate | — | — | TiO2 | 80 | YES | Ethanol | Reduction treatment at 80° | — |
| | | | | | | | | | C. for 1 hr. | |
| 27 | Ru | Chloride | — | — | TiO2 | 78 | YES | Ethanol | Reduction treatment at 80° | — |
| | | | | | | | | | C. for 1 hr. | |
| 28 | Ru | Acetate | — | — | TiO2 | 80 | YES | Ethanol | Reduction treatment at 80° | — |
| | | | | | | | | | C. for 1 hr. | |
| 29 | Ru | Oxalate | — | — | TiO2 | 78 | YES | Ethanol | Reduction treatment at 80° | — |
| | | | | | | | | | C. for 1 hr. | |
| 30 | Ru | Bromide | — | — | TiO2 | 80 | YES | Ethanol | Reduction treatment at 80° | — |
| | | | | | | | | | C. for 1 hr. | |
| 31 | Ru | Iodide | — | — | TiO2 | 78 | YES | Ethanol | Reduction treatment at 80° | — |
| | | | | | | | | | C. for 1 hr. | |
| 32 | Ru | Ammine | — | — | TiO2 | 60 | YES | Ethanol | Reduction treatment at 80° | — |
| | | chloride | | | | | | | C. for 1 hr. | |
| 33 | Ru | Ammine | — | — | TiO2 | 75 | YES | Ethanol | Reduction treatment at 80° | — |
| | | hydroxide | | | | | | | C. for 1 hr. | |
| 34 | Ru | Ammine | — | — | TiO2 | 85 | YES | Ethanol | Reduction treatment at 80° | — |
| | | nitrate | | | | | | | C. for 1 hr. | |
| 35 | Ir | Chloride | — | — | TiO2 | 70 | YES | Ethanol | Reduction treatment at 80° | — |
| | | | | | | | | | C. for 1 hr. | |
| 36 | Ir | Bromide | — | — | TiO2 | 65 | YES | Ethanol | Reduction treatment at 80° | — |
| | | | | | | | | | C. for 1 hr. | |
| 37 | Ir | Iodide | — | — | TiO2 | 65 | YES | Ethanol | Reduction treatment at 80° | — |
| | | | | | | | | | C. for 1 hr. | |
| 38 | Ir | Ammine | — | — | TiO2 | 75 | YES | Ethanol | Reduction treatment at 80° | — |
| | | chloride | | | | | | | C. for 1 hr. | |
| 39 | Ir | Ammine | — | — | TiO2 | 58 | YES | Ethanol | Reduction treatment at 80° | — |
| | | hydroxide | | | | | | | C. for 1 hr. | |
| 40 | Ir | Ammine | — | — | TiO2 | 67 | YES | Ethanol | Reduction treatment at 80° | — |
| | | nitrate | | | | | | | C. for 1 hr. | |
| 41 | Ru | Nitrate | — | — | SiO2 | 88 | YES | Ethanol | Reduction treatment at 80° | — |
| | | | | | | | | | C. for 1 hr. | |
| 42 | Ru | Nitrate | — | — | ZrO2 | 88 | YES | Ethanol | Reduction treatment at 80° | — |
| | | | | | | | | | C. for 1 hr. | |
| 43 | Ru | Nitrate | — | — | TiO2— | 92 | YES | Ethanol | Reduction treatment at 80° | — |
| | | | | | SiO2 | | | | C. for 1 hr. | |
| 44 | Ru | Nitrate | — | — | TiO2— | 91 | YES | Ethanol | Reduction treatment at 80° | — |
| | | | | | ZrO2 | | | | C. for 1 hr. | |
| 45 | Ru | Nitrate | WO3 | 10 | TiO2 | 88 | YES | Ethanol | Reduction treatment at 80° | — |
| | | | | | | | | | C. for 1 hr. | |
| 46 | Ru | Nitrate | WO3 | 20 | TiO2 | 84 | YES | Ethanol | Reduction treatment at 80° | — |
| | | | | | | | | | C. for 1 hr. | |
| 47 | Ru | Nitrate | WO3 | 30 | TiO2 | 91 | YES | Ethanol | Reduction treatment at 80° | — |
| | | | | | | | | | C. for 1 hr. | |
| 48 | Ru | Nitrate | MoO3 | 10 | TiO2 | 83 | YES | Ethanol | Reduction treatment at 80° | — |
| | | | | | | | | | C. for 1 hr. | |
| 49 | Ru | Nitrate | MoO3 | 20 | TiO2 | 83 | YES | Ethanol | Reduction treatment at 80° | — |
| | | | | | | | | | C. for 1 hr. | |
| 50 | Ru | Nitrate | MoO3 | 30 | TiO2 | 89 | YES | Ethanol | Reduction treatment at 80° | — |
| | | | | | | | | | C. for 1 hr. | |
| 51 | Ru | Nitrate | — | — | TiO2 | 77 | YES | Sodium | Reduction treatment at 80° | — |
| | | | | | | | | citrate | C. for 1 hr. | |
| 52 | Ru | Nitrate | — | — | TiO2 | 78 | YES | Potassium | Reduction treatment at 80° | — |
| | | | | | | | | citrate | C. for 1 hr. | |
| 53 | Ru | Nitrate | — | — | TiO2 | 80 | YES | Acetic acid | Reduction treatment at 80° | — |
| | | | | | | | | | C. for 1 hr. | |
| 54 | Ru | Nitrate | — | — | TiO2 | 65 | YES | Formic acid | Reduction treatment at 80° | — |
| | | | | | | | | | C. for 1 hr. | |
| 55 | Ru | Nitrate | — | — | TiO2 | 74 | YES | Malic acid | Reduction treatment at 80° | — |
| | | | | | | | | | C. for 1 hr. | |
| 56 | Ru | Nitrate | — | — | TiO2 | 81 | YES | Methanol | Reduction treatment at 80° | — |
| | | | | | | | | | C. for 1 hr. | |
| 57 | Ru | Nitrate | — | — | TiO2 | 74 | YES | Propanol | Reduction treatment at 80° | — |
| | | | | | | | | | C. for 1 hr. | |
| 58 | Ru | Nitrate | — | — | TiO2 | 80 | YES | Diethyl ether | Reduction treatment at 80° | — |
| | | | | | | | | | C. for 1 hr. | |
| 59 | Ru | Nitrate | — | — | TiO2 | 71 | YES | Methyl ethyl | Reduction treatment at 80° | — |
| | | | | | | | | ketone | C. for 1 hr. | |
| 60 | Ru | Nitrate | — | — | TiO2 | 60 | YES | — | — | (Ru/TiO2)/ |
| | | | | | | | (84%) | | | TiO2 |
| 61 | Ru | Nitrate | — | — | TiO2 | 70 | YES | Ethanol | Reduction treatment at 80° | (Ru/TiO2)/ |
| | | | | | | | (84%) | | C. for 1 hr. | TiO2 |
| | | | — | — | | | | | | |
| Comp. | Ru (solid | Nitrate | — | — | TiO2 | 30 | NO | — | — | — |
| Ex. 1 | prepared by | | | | | | (16%) | | | |
| | immersion) | | | | | | | | | |
| Comp. | Ru | Nitrate | — | — | TiO2 | 15 | NO | — | — | — |
| Ex. 2 | | | | | | | (30%) | | | |
| Comp. | Ru | Nitrate | — | — | TiO2 | 18 | NO | — | — | — |
| Ex. 3 | | | | | | | (40%) | | | |

### INDUSTRIAL APPLICABILITY

The SO₃ reduction catalyst for purifying an exhaust gas, preparation process of the catalyst and exhaust gas purifying method using the catalyst, each according to the present invention, can be used widely for chemical plants which must industrially purify an SO₃-containing exhaust gas.

1. A process for producing an SO₃ reduction catalyst for purifying an exhaust gas, comprising the steps of:
immersing a honeycomb substrate in a metal colloid solution for 30 seconds to 5 hours to allow Ru to be supported by the substrate, the concentration of Ru in the metal colloid solution being from 0.5 mmol-Ru/L to 140 mmol-Ru/L; and
drying and calcining the resulting substrate.

2. The process of claim 1, wherein the substrate comprises at least one material selected from titania, silica, zirconia, and composite oxides thereof.

3. The process of claim 1, wherein the SO₃ reduction catalyst further comprises at least one promoter selected from WO₃ and MoO₃, wherein the at least one promoter is present in an amount less than 30 wt. % based on the total weight of the SO₃ reduction catalyst.

4. The process of claim 1_{;} further comprising subjecting an aqueous solution of a metal salt to a reduction treatment to obtain metal colloid particles, wherein the reduction treatment comprises heating the aqueous solution to a temperature ranging from 80 to 100° C. for 30 minutes to 120 minutes.

5. A process for producing an SO₃ reduction catalyst for purifying an exhaust gas, comprising the steps of:
immersing a honeycomb substrate in a metal colloid solution for 30 seconds to 5 hours to allow Ir to be supported by the substrate, the concentration of Ir in the metal colloid solution being from 0.5 mmol-Ir/L to 140 mmol-Ir/L; and
drying and calcining the resulting substrate.

6. The process of claim 5, wherein the substrate comprises at least one material selected from titania, silica, zirconia, and composite oxides thereof.

7. The process of claim 5, wherein the SO₃ reduction catalyst further comprises at least one promoter selected from WO₃ and MoO₃, wherein the at least one promoter is present in an amount less than 30 wt. % based on the total weight of the SO₃ reduction catalyst.

8. The process of claim 5, further comprising subjecting an aqueous solution of a metal salt to a reduction treatment to obtain metal colloid particles, wherein the reduction treatment comprises heating the aqueous solution to a temperature ranging from 80 to 100° C. for 30 minutes to 120 minutes.

9. A process for producing an SO₃ reduction catalyst for purifying an exhaust gas, comprising the steps of:
immersing a honeycomb substrate for 30 seconds to 5 hours in an aqueous solution containing at least one material selected from the group consisting of nitrates, chlorides, bromides, sulfates, acetates, oxalates, iodides, amine chlorides, amine hydroxides and amine nitrates of Ru, the concentration of Ru in the aqueous solution being 0.5 mmol-Ru/L to 0.4 mol-Ru/L; and
drying and calcining the resulting substrate.

10. The process of claim 9, wherein the substrate comprises at least one material selected from titania, silica, zirconia, and composite oxides, thereof.

11. The process of claim 9, wherein the SO₃ reduction catalyst further comprises at least one promoter selected from WO₃ and MoO₃, wherein the at least one promoter is present in an amount less than 30 wt. % based on the total weight of the SO₃ reduction catalyst.

12. A process for producing an SO₃ reduction catalyst for purifying an exhaust gas, comprising the steps of:
immersing a honeycomb substrate for 30 seconds to 5 hours in an aqueous solution containing at least one material selected from the group consisting of nitrates, chlorides, bromides, sulfates, acetates, oxalates, iodides, amine chlorides, amine hydroxides and amine nitrates of Ir, the concentration of Ir in the aqueous solution being 0.5 mmol-Ir/L to 0.4 mol-Ir/L; and
drying and calcining the resulting substrate.

13. The process of claim 12, wherein the substrate comprises at least one material selected from titania, silica, zirconia, and composite oxides thereof.

14. The process of claim 12, wherein the SO₃ reduction catalyst further comprises at least one promoter selected from WO₃ and MoO₃, wherein the at least one promoter is present in an amount less than 30 wt. % based on the total weight of the SO₃ reduction catalyst.

15. A process for producing an SO₃ reduction catalyst for purifying an exhaust gas, comprising the steps of:
converting, into a slurry, a catalyst powder obtained by immersing a powder of a raw material of a substrate in a metal colloid solution to allow Ru to be supported on the substrate, the concentration of Ru in the metal colloid solution being from 0.5 mmol-Ru/L to 140 mmol-Ru/L; and
drying and calcining the resulting substrate

16. The process of claim 15, wherein the substrate comprises at least one material selected from titania, silica, zirconia, and composite oxides thereof.

17. The process of claim 15, wherein the SO₃ reduction catalyst further comprises at least one promoter selected from WO₃ and MoO₃, wherein the at least one promoter is present in an amount less than 30 wt. % based on the total weight of the SO₃ reduction catalyst.

18. A process for producing an SO₃ reduction catalyst for purifying an exhaust gas, comprising the steps of:
converting, into a slurry, a catalyst powder obtained by immersing a powder of a raw material of a substrate in a metal colloid solution to allow Ir to be supported on the substrate, the concentration of Ir in the metal colloid solution being adjusted to from 0.5 mmol-Ir/L to 140 mmol-Ir/L; and
drying and calcining the resulting substrate.

19. The process of claim 18, wherein the substrate comprises at least one material selected from titania, silica, zirconia, and composite oxides thereof.

20. The process of claim 18, wherein the SO₃ reduction catalyst further comprises at least one promoter selected from WO₃ and MoO₃, wherein the at least one promoter is present in an amount less than 30 wt. % based on the total weight of the SO₃ reduction catalyst.
